(19) United States
(12) Patent Application Publication
(10) Pub. No.: US 2022/0304511 A1
(43) Pub. Date: Sep. 29, 2022

(54) VACUUM FOOD PROCESSING SYSTEM

(71) Applicant: SHARKNINJA OPERATING LLC, NEEDHAM, MA (US)

(72) Inventors: Sam William Bannister, Leybourne (GB); Michael Ting, Boston, MA (US); Kristof Benedict Fogarasi, Norwood, MA (US); Nicholas Michael O'Loughlin, Hong Kong (CN)

(73) Assignee: SHARKNINJA OPERATING LLC, NEEDHAM, MA (US)

(21) Appl. No.: 17/618,300

(22) PCT Filed: Jun. 12, 2020
(86) PCT No.: PCT/US2020/037484

§ 371 Date: Dec. 10, 2021

Related U.S. Application Data
(60) Provisional application No. 62/861,812, filed on Jun. 14, 2019.

(51) Int. Cl. A47J 43/046; A47J 43/07

(52) U.S. Cl. CPC A47J 43/046; A47J 43/0716; A47J 43/0727

(57) ABSTRACT

An accessory for use in a food processing system having a processing chamber in a container with an interior surface and a rotatable blade assembly, the accessory including an accessory body receivable within the processing chamber of the attachment. The accessory body has an upper end, a lower end, and at least one sidewall extending between the first end and the second end to define an accessory interior. An opening to the accessory interior is arranged at the upper end and a filtering body extends from the accessory body. The filtering body is associable with the interior surface of the container to create an exit channel from the processing chamber.

### BACKGROUND

Exemplary embodiments of the present invention relate to a blender, and more particularly to a container of a blender configured to receive one or more food items therein.

Blenders are commonly used to process a plurality of different food products, including liquids, solids, semi-solids, gels and the like. It is well-known that blenders are useful devices for blending, cutting, and dicing food products in a wide variety of commercial settings, including home kitchen use, professional restaurant or food services use, and large-scale industrial use. They offer a convenient alternative to chopping or dicing by hand, and often come with a range of operational settings and modes adapted to provide specific types or amounts of food processing, e.g., as catered to particular food products.

Several benefits can be achieved by forming a vacuum within a blender container or attachment either prior to or after a blending operation. For example, by forming a vacuum prior to a blending operation, the overall degradation of the nutritional properties of the ingredients being processes may be reduced. Accordingly, a blender container or attachment may include a seal that is movable to selectively form a vacuum within the blender container. However, when the blender container is used in high vibration environments, such as in a vehicle or when the container is being carried in a bag for example, it is possible that liquid or other ingredients from the interior of the blender container may leak through the seal.

### SUMMARY

According to an embodiment, an accessory for use in a food processing system having a processing chamber in a container with an interior surface and a rotatable blade assembly, the accessory including an accessory body receivable within the processing chamber of the attachment. The accessory body has an upper end, a lower end, and at least one sidewall extending between the first end and the second end to define an accessory interior. An opening to the accessory interior is arranged at the upper end and a filtering body extends from the accessory body. The filtering body is associable with the interior surface of the container to create an exit channel from the processing chamber.

In addition to one or more of the features described above, or as an alternative, in further embodiments a filtering flange connects said filtering body to said accessory body, said filtering flange being positioned to block a portion of a flow from said processing chamber in an area adjacent said exit channel.

In addition to one or more of the features described above, or as an alternative, in further embodiments at least a portion of said sidewall is permeable to a fluid flow.

In addition to one or more of the features described above, or as an alternative, in further embodiments said filtering body is positionable within the processing chamber such that said exit channel is aligned with a spout of the container.

In addition to one or more of the features described above, or as an alternative, in further embodiments said upper end includes a spout region disposed a greater distance from the interior surface of the container than a remainder of said upper end.

In addition to one or more of the features described above, or as an alternative, in further embodiments said filtering body extends downwardly from said spout region of said accessory body.

In addition to one or more of the features described above, or as an alternative, in further embodiments said filtering body includes an abutting end for contacting the interior surface of the container, said abutting end having a notch formed therein.

In addition to one or more of the features described above, or as an alternative, in further embodiments said notch and the interior surface of the container cooperate to define an exit channel.

In addition to one or more of the features described above, or as an alternative, in further embodiments said accessory body further comprises a lid configurable to selectively seal said opening at said upper end.

In addition to one or more of the features described above, or as an alternative, in further embodiments said lid is removably associated with said upper end.

In addition to one or more of the features described above, or as an alternative, in further embodiments said lid is rotatably coupled to said upper end.

In addition to one or more of the features described above, or as an alternative, in further embodiments said lower end of said accessory body is positionable in contact with a bottom surface of the processing chamber.

In addition to one or more of the features described above, or as an alternative, in further embodiments said accessory body includes a first portion adjacent said lower end and a second portion adjacent said upper end, said first portion and said second portion having different configurations.

In addition to one or more of the features described above, or as an alternative, in further embodiments at least one of said first portion and said second portion is generally cylindrical in shape and the other of said first portion and said second portion is generally frustoconical in shape.

In addition to one or more of the features described above, or as an alternative, in further embodiments comprising an opening to said accessory interior at said lower end, wherein a diameter of said opening at said lower end is greater than a diameter of the rotatable blade assembly.

According to another embodiment, a container assembly for a food processing system includes a sealable container body including a processing chamber having an interior surface and an open end, a rotatable blade assembly including at least one blade positioned within the chamber of the sealable body, and an accessory positionable within the chamber. The accessory includes an accessory body having an accessory interior, an upper end in communication with the accessory interior, and a filtering body extending from the accessory body. The filtering body being associable with the interior surface of the container body to create an exit channel from the processing chamber.

In addition to one or more of the features described above, or as an alternative, in further embodiments a filtering flange connects said filtering body to said accessory body, said filtering flange being positioned to block a portion of a flow from said processing chamber in an area adjacent said exit channel.

In addition to one or more of the features described above, or as an alternative, in further embodiments said accessory body includes a sidewall and at least a portion of said sidewall is permeable to a fluid flow.

In addition to one or more of the features described above, or as an alternative, in further embodiments said container body includes a spout and said exit channel is aligned with said spout.

In addition to one or more of the features described above, or as an alternative, in further embodiments said upper end includes a spout region disposed a greater distance from an interior surface of said container body than a remainder of said upper end.

In addition to one or more of the features described above, or as an alternative, in further embodiments said filtering body extends downwardly from said spout region of said accessory body.

In addition to one or more of the features described above, or as an alternative, in further embodiments said filtering body includes an abutting end for contacting an interior surface of the container, said abutting end having a notch formed therein.

In addition to one or more of the features described above, or as an alternative, in further embodiments said notch and the interior surface of the container cooperate to define an exit channel.

In addition to one or more of the features described above, or as an alternative, in further embodiments said accessory further comprises a lid connectable to said accessory body to seal said accessory interior.

In addition to one or more of the features described above, or as an alternative, in further embodiments said sealable container body includes a vacuum channel selectively arranged in fluid communication with said processing chamber.

### BRIEF DESCRIPTION OF THE FIGURES

The accompanying drawings incorporated in and forming a part of the specification embodies several aspects of the present invention and, together with the description, serves to explain the principles of the invention. In the drawings:

FIG. 1 is a perspective view of an example of a food processing system;

FIG. 2 is a perspective view of a base of a food processing system;

FIG. 3 is a perspective view of a food processing system including an attachment different from the attachment of FIG. 1;

FIG. 3A is a perspective view of an attachment of the food processing system;

FIG. 4 is a cross-sectional view of the food processing system of FIG. 3 according to an embodiment;

FIG. 5 is a perspective view of a vacuum attachment suitable for use with a food processing system according to an embodiment;

FIG. 6 is a cross-sectional view of the vacuum attachment of FIG. 6 according to an embodiment;

FIG. 7 is a perspective cross-sectional view of a lid of a vacuum attachment according to an embodiment;

FIG. 8 is a top perspective view of an accessory suitable for use with an attachment according to an embodiment;

FIG. 9 is a side perspective view of an accessory suitable for use with an attachment according to an embodiment;

FIG. 10 is a cross-sectional view of the accessory installed within the attachment according to an embodiment;

FIG. 11 is a top view of the accessory installed within the attachment according to an embodiment; and

FIG. 12 is a side cross-sectional view of the accessory installed within the attachment according to an embodiment during a pouring operation.

The detailed description explains embodiments of the invention, together with advantages and features, by way of example with reference to the drawings.

### DETAILED DESCRIPTION

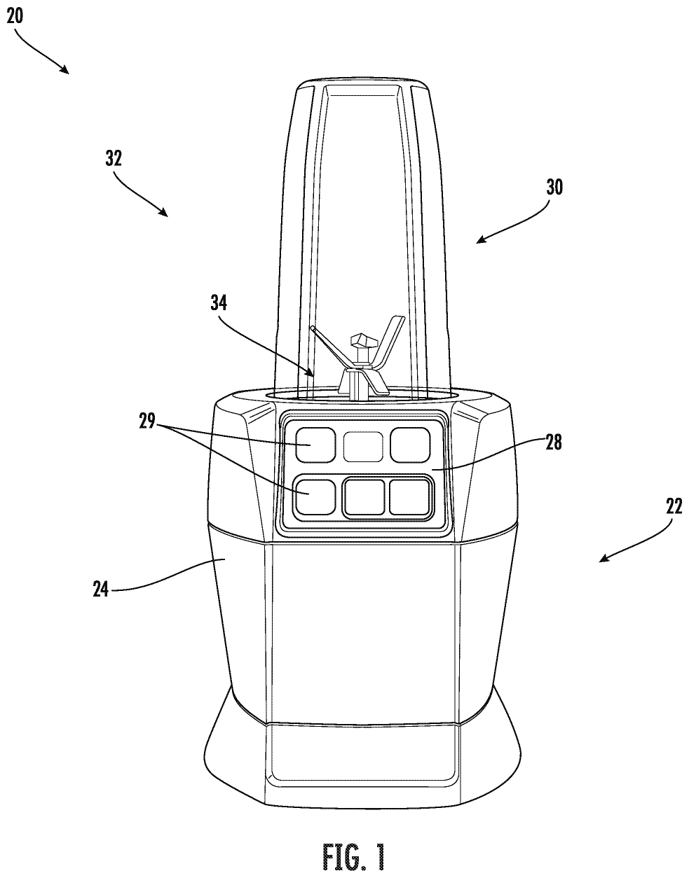

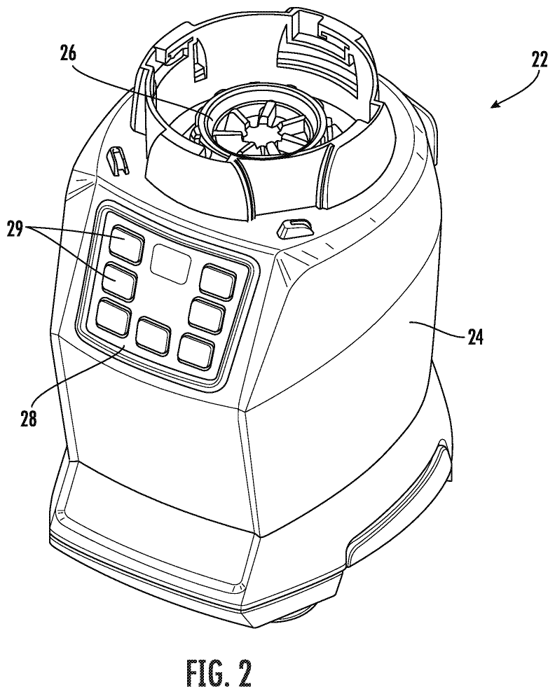

Referring now to FIGS. 1 and 2, an example of a multi-functional food processing system 20 is illustrated. In general, the food processing system 20 can be adapted to perform any food processing or blending operation including as non-limiting examples, dicing, chopping, cutting, slicing, mixing, blending, stirring, crushing, or the like. The food processing 20 system includes a base 22 having a body or housing 24 within which a motorized unit (not shown) and at least one controller (not shown) are located. The base 22 includes at least one rotary component, such as a drive coupler 26 (see FIG. 2) for example, driven by the motorized unit located within the housing 24. The base 22 additionally includes a control panel or user interface 28 having one or more inputs 29 for turning the motorized unit on and off and for selecting various modes of operation, such as pulsing, blending, or continuous food processing. The drive coupler 26 is configured to engage a portion of an attachment 30 coupled to the base 22 for the processing of food products located within an interior of the attachment 30. This will become more apparent in subsequent FIGS. and discussion.

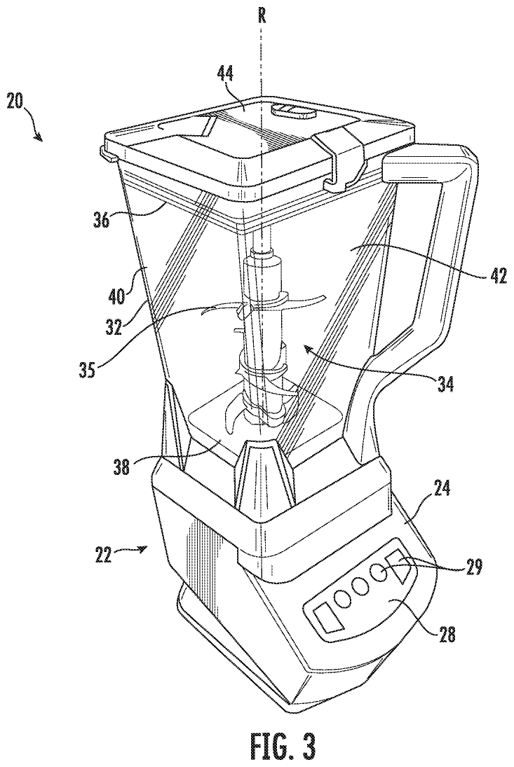

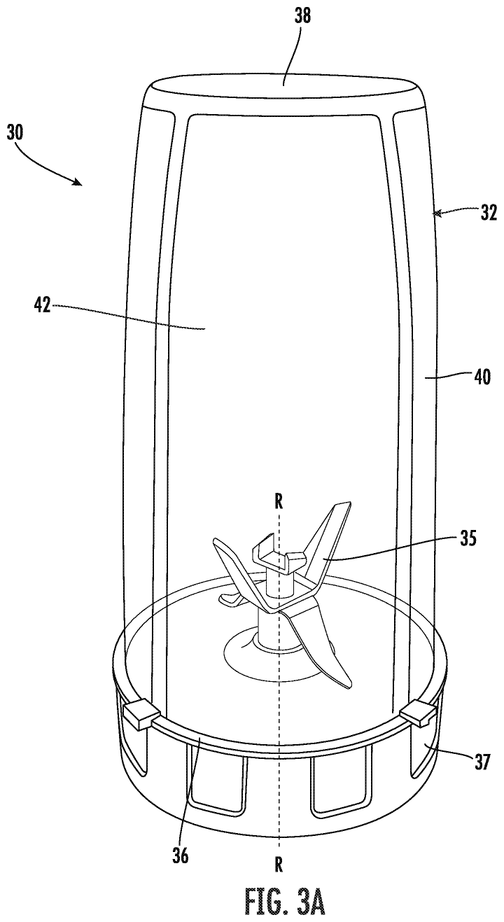

One or more attachments 30 varying in size and/or functionality may be configured for use with the base 22. An example of an attachment 30 is shown in FIG. 3 and includes ajar or container 32 having a rotatable blade assembly 34 including one or more blades 35 drivable about an axis of rotation R to perform a food processing operation. In some embodiments, the container 32 is a pitcher and may be sized to hold approximately 72 fluid ounces. However, embodiments where the container 32 has a larger or smaller capacity are also within the scope of the disclosure. As shown, the container 32 typically includes a first open end 36, a second closed end 38, and one or more sidewalls 40 extending between the first end 36 and the second end 38 to define a hollow processing chamber 42 of the container 32. The rotatable blade assembly 34 may be integrally formed with the second end 38 of the container 32, or alternatively, may be removably coupled thereto. The attachment 30 may additionally include a lid 44 configured to couple to the first open end 36 of the container 32 to seal the container 32. The second sealed end 38 of the attachment 30 of FIG. 3 is configured to mount to the base 22 and includes a coupling (not shown) configured to cooperate with the coupling 26 of the base 22 to perform a food processing operation. Accordingly, the orientation of the container 32 when the attachment 30 is connected to the base 22 and separated from the base 22 remains generally constant.

Another example of an attachment 30 suitable for use with the base 22 is illustrated in FIGS. 1 and 3A. In the illustrated, non-limiting embodiment, the attachment 30 includes an inverted jar or container 32 having a rotatable blade assembly 34 coupled thereto. Similar to the attachment of FIG. 3, the container 32 typically includes a first open end 36, a second closed end 38, and one or more sidewalls 40 extending between the first end 36 and the second end 38. The sidewalls 40 in combination with one or more of the ends 36, 38 of the container 32 define a hollow processing chamber 42 of the container 32. In embodiments where the attachment 30 is a personal blending container that has a first configuration when separated from the base 22 and a second inverted configuration when coupled to the base 22, the rotatable blade assembly 34 includes a base 37 that is configured to removably couple to the first open end 36 of the container 32 to seal the processing chamber 42.

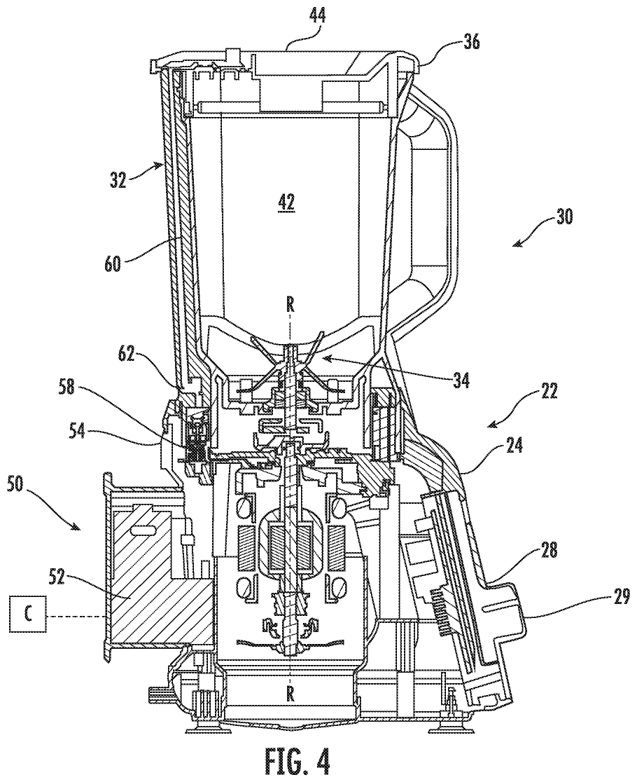

In an embodiment, the food processing system 20 is operable to perform a vacuum operation. Accordingly, as best shown in FIG. 4, the base 22 of the food processing system 20 may additionally include a vacuum system 50 having a mechanism 52 capable of drawing a vacuum, such as a vacuum pump for example. However, any mechanism capable of drawing a vacuum is contemplated herein. At least one attachment 30 configured for use with the base 22 is operably coupled to the vacuum mechanism 52 when the attachment 30 is connected with the base 22. In the illustrated, non-limiting embodiment, the vacuum mechanism 52 is arranged at a side 54 of the base 22, such as at the rear thereof, to allow one or more attachments 30 having varying configurations to easily couple to the vacuum mechanism 52. The vacuum mechanism 52 may be operably coupled to a controller, illustrated schematically at C, such that the vacuum mechanism 52 is operated by the controller C in response to actuation of one or more inputs 29 of the user interface 28.

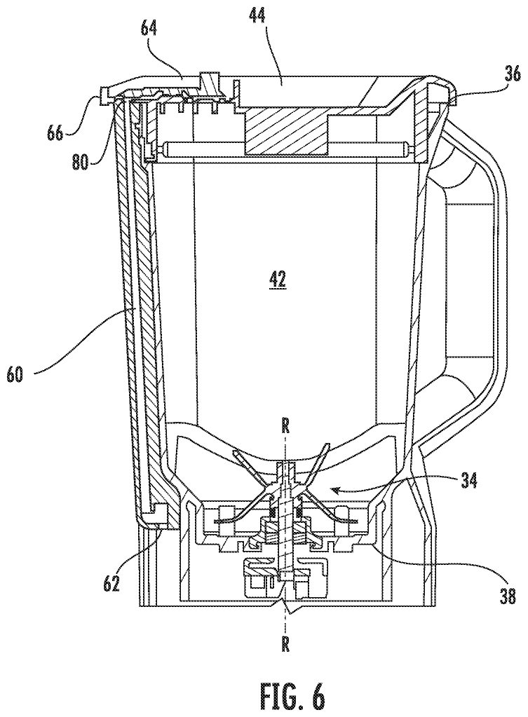

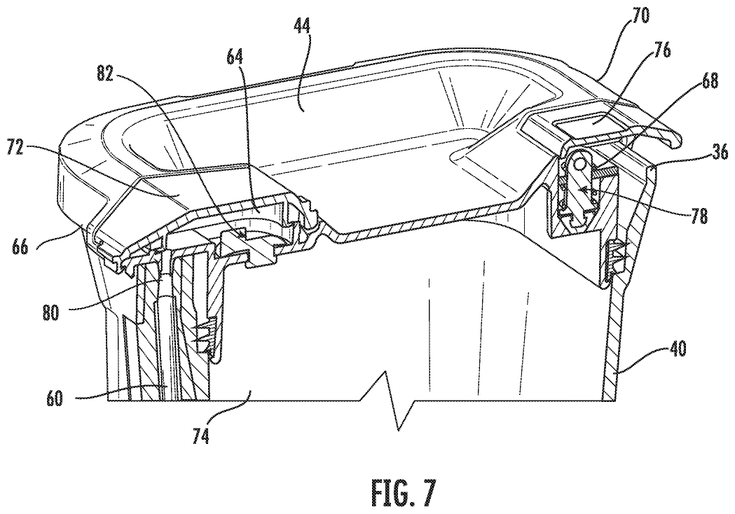

In an embodiment, one or more of the attachments 30 previously described are vacuum containers suitable for performing a vacuum operation of the food processing system 20. With reference now to FIGS. 4-7, the pitcher container 32 additionally includes a vacuum passage or conduit 60 configured to fluidly connect the vacuum mechanism 52 when the attachment 30 is coupled to the base 22. The vacuum passage 60 may have a generally linear configuration as shown in FIG. 7, or alternatively, may have one or more bends or angles formed therein. Because the vacuum mechanism 52 is located at a side 54 of the base 22, a first end 62 of the vacuum passage 60 configured to abut with a surface of the base 22 to fluidly couple to the vacuum mechanism 52 is similarly located adjacent a corresponding side of the container 32. In an embodiment, a portion of the vacuum system 50 is arranged adjacent an upper surface 58 of the base 22. As a result, the first end 62 of the vacuum passage 60 may be vertically offset from the second end 38 of the container 32. However, embodiments where the first end 62 of the vacuum passage 60 is aligned with an adjacent end of the container 32 are also considered herein.

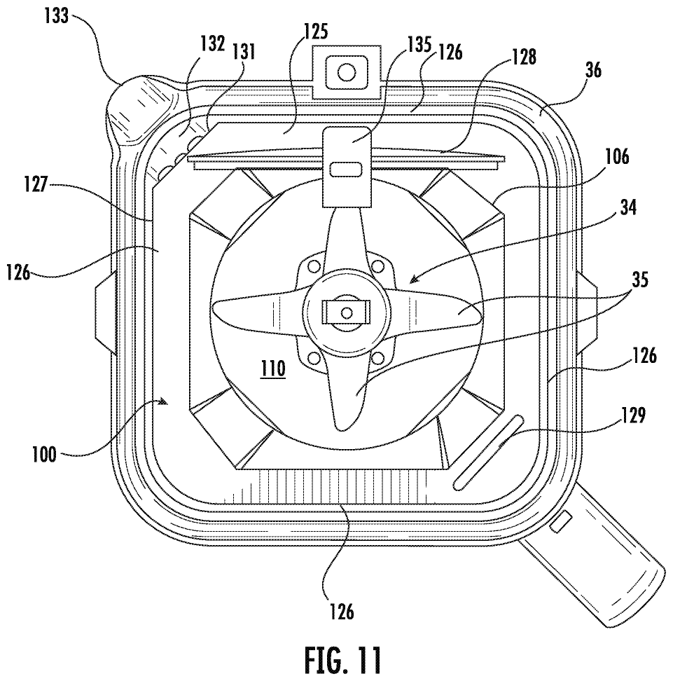

In an embodiment, the vacuum passage 60 is integrally formed with the body of the container 32. As best shown in FIG. 11, the vacuum passage 60 is embedded within a sidewall 40 of the container 32. However, in other embodiments, the vacuum passage 60 may be arranged at an exterior of the container 32. In such embodiments, the vacuum passage 60 may be at least partially defined by the sidewall 40 of the container 32, or alternatively, may be completely separate from the sidewall 40. Accordingly, the vacuum passage 60 may be formed with the container 32 such as via an additive manufacturing or injection molding process for example.

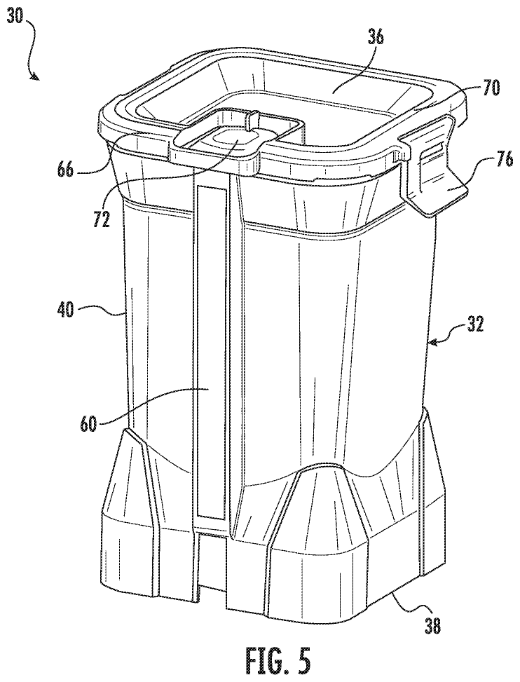

The lid 44 configured to selectively couple to the first open end 36 of the pitcher container 32 has at least one internal chamber formed therein, defined at least partially by a wall of the lid 44. As shown, the lid 44 may include a first chamber 64 located at a first side 66 thereof, and in some embodiments may include a second chamber 68 arranged adjacent a second side 70 thereof. Although the first chamber 64 and the second chamber 68 are shown as being disposed at opposite sides of the lid 44 (FIG. 7), or alternatively, at adjacent sides of the lid 44 (FIG. 5), embodiments where the chambers 64, 68 are formed at the same side of the lid 44 are also within the scope of the disclosure.

In an embodiment, the lid 44 includes at least one component, such as a flap 72 for example, movable between a first closed position and a second open position, relative to the lid 44. When the flap 72 is in the first closed position, an interior facing surface 74 of the flap 72 defines an upper extent of first chamber 64. Alternatively, or in addition, a second flap 76 pivotal between a first closed position and a second open position, may be associated with access or operation of a release mechanism 78 disposed within the second chamber 68. Operation of the release mechanism 78 is configured to break the vacuum within the processing chamber 42 of the container 32, by allowing ambient air to flow therein.

When the lid 44 is affixed to the first open end 36 of the container 32, the first chamber 64 is arranged in fluid communication with the second end 80 of the vacuum passage 60 formed in the container 32. Accordingly, the first chamber 64 may be considered a vacuum chamber. In such embodiments, a second end 80 of the vacuum passage 60 may extend into or directly couple with the vacuum chamber 64. However, because the vacuum chamber 64 is disposed in the lid 44, in other embodiments, the vacuum passage 60 does not extend beyond the end 36 of the container 32. As a result, a portion of the vacuum passage 60 may be at least partially defined by the lid 44.

Further, a vacuum sealing assembly 82 movable between a sealed position and a unsealed position is disposed within the vacuum chamber 64 in fluid communication with the processing chamber 42 of the container 32. During a vacuum operation, the force applied to the vacuum sealing assembly 82 via the vacuum mechanism 52 causes the vacuum sealing assembly 82 to transform from a sealed position to an unsealed position. As a result, air from within the processing chamber 42 of the container 32 is evacuated from the processing chamber 42 via the vacuum passage 60. Once operation of the vacuum mechanism 52 ceases, the vacuum sealing assembly 82 will bias back to the sealed position, thereby preventing the flow of air into the processing chamber 42 such that a negative pressure is maintained therein. Although a vacuum sealing assembly 82 including an umbrella valve having a flange movable to selectively expose an opening in fluid communication with the processing chamber 42 is shown in the FIGS., it should be understood that any suitable vacuum sealing assembly 82 is within the scope of the disclosure.

A vacuum operation may be performed after food has been disposed within the processing chamber 42 but prior to performing a food processing operation. In another embodiment, a vacuum operation is initiated to draw a vacuum within the processing chamber 42 after a food processing operation has been performed. Forming a vacuum after a blending operation may be used to increase the shelf life or storage of the food products within the attachment 30. After a vacuum has been generated within the processing chamber 42 of the container 32 it is difficult, if not impossible to access the food product within the processing chamber 42 as a result of the forces acting thereon. Accordingly, a user should first break the vacuum within the container 32 by operating the release mechanism 78, thereby venting the processing chamber 42 of the container 32 to ambient via a release path, prior to accessing the contents within the interior 42 of the container 32.

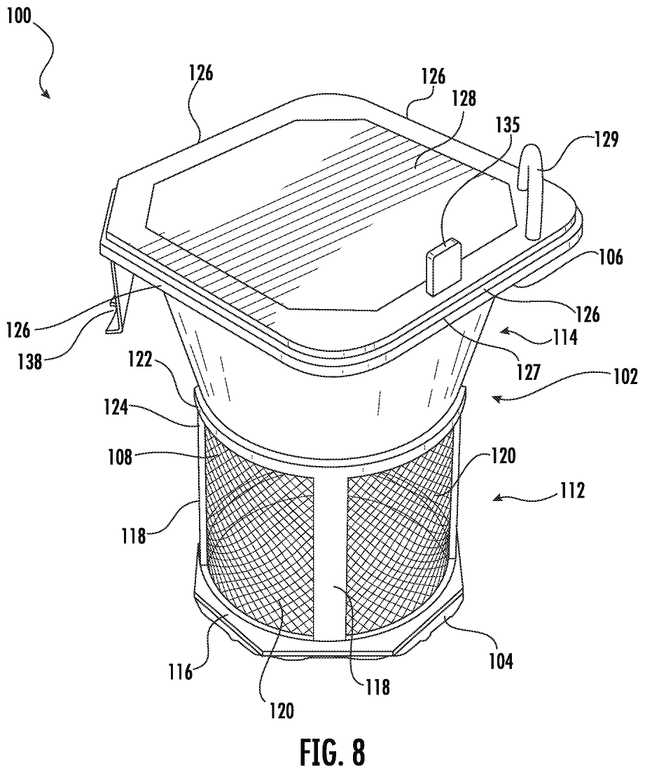

With reference now to FIGS. 8-12 an example of an accessory 100 suitable for use with at least one attachment of the system 20 is shown. For example, the accessory 100 may be a strainer positionable within the processing chamber 42 of the pitcher container 32. The strainer 100 includes an accessory body 102 having an open first lower end 104, an open second upper end 106, and a plurality of sidewalls 108 extending between the first lower end 104 and the second upper end 106 to define an accessory interior 110 of the strainer 100. In the illustrated, non-limiting embodiment, the accessory body 102 includes a first portion 112 located adjacent the first end 104 and having a first configuration and a second portion 114 arranged adjacent the second end 106 and having a second configuration distinct from the first configuration. The second portion 114 may be integrally formed, or alternatively, may be removably mountable to the first portion 112. However, embodiments where the contour of the accessory body 102 remains generally uniform between the first end 104 and the second end 106 thereof are also within the scope of the disclosure.

As shown, the first portion 112 of the accessory body 102 may be generally cylindrical in shape and include an annular base 116, such as formed from a plastic material for example, configured to abut an end of the processing chamber 42. In an embodiment, the opening formed at the first end 104 of the accessory body 102 is sized to position the strainer 100 concentrically with the one or more rotatable blades 35 of the blade assembly 34 such that the rotatable blades 35 are located and freely operable within the accessory interior 110 of the strainer 100. In an embodiment, a contour of the annular base 116 is selected to properly position the strainer 100 within the processing chamber 42 and/or restrict unintended movement of the strainer 100 within the processing chamber 42.

A plurality of support members 118 extend upwardly from the annular base 116. Although the support members 118 are illustrated with a vertical orientation, embodiments where the support members 118 have another configuration are also within the scope of the disclosure. A partially permeable or porous material 120 extends between each of the plurality of support members 118 to define the sidewall 108 of the first portion 112. In an embodiment, the partially porous material 120 is a mesh or screen-like material having a plurality of small openings formed therein. The openings may be sized to allow a portion of the contents located within the accessory interior 110, such as liquid or blended food particles for example, to migrate outwardly from the accessory interior 110 defined by the first portion 112 of the strainer 100 into the processing chamber 42 of the pitcher container 32. The openings may similarly be sized to restrict the flow of a portion of the contents of the accessory interior 110 therefore, such as pulp or waste for example.

In the illustrated, non-limiting embodiment, the second portion 114 of the accessory body 102 has a funnel-like or frustoconical shape. As shown, the end 122 of the second portion 114 is generally complementary in size to the adjacent end 124 of the first portion 112. Because the portion of the sidewalls 108 that define the second portion 114 are angled outwardly relative to a central axis of the strainer 100, an internal diameter at the second upper end 106 of the accessory body 102 is greater than an internal diameter at the first lower end 104 of the accessory body 102. However, it should be understood that a second portion 114 having any shape is within the scope of the disclosure. In an embodiment shown in the FIGS., within the second portion 114, the sidewalls 108 are formed from a substantially solid, non-permeable material, such that none of the contents disposed within the accessory interior 110 of the strainer 100 is able to pass through the sidewalls 108 at the second portion 114 of the body 102.

Although the portion of the sidewalls 108 defined by the second portion 114 of the body 102 are illustrated as being substantially solid, embodiments where the sidewalls include an at least partially permeable material are also contemplated herein.

In an embodiment, the second upper end 106 of the accessory body 102 includes an outwardly extending flange 125, also referred to herein as a filtering flange, having one or more sides 126. The contour of the sides 126 of the flange is generally complementary to the interior of the pitcher container 32. For example, the flange 125 may be generally rectangular, and in some embodiments, square in shape, and in an embodiment, at least a portion of each side 126 abuts a corresponding sidewall 40 of the pitcher container 32. Alternatively, a sealing element 127 arranged about an outer periphery of the flange 125 may contact the sidewalls 40 of the pitcher container 32 in place of the flange 125. This sealing element may aid in restricting movement of the strainer 100 relative to the pitcher container 32 during not only a pouring operation, such as when the pitcher container 32 is in a tilted configuration, but also during a processing operation.

A lid 128 may be associated with to the second end 106 of the accessory body 102. The lid 128 may be removably connected to the accessory body 102, or alternatively, may be rotatably coupled thereto. In an embodiment, the lid 128 is formed from a generally solid material and has a contour complementary to the contour of the second upper end 106 of the body 102. The lid 128 may be connected to the accessory body 102 via any suitable connection mechanism including, but not limited to, a pressure-tight seal, a snap-fit engagement, and a threaded connection for example. It should be understood that any type of connection formed between the lid 128 and the accessory body 102 is contemplated herein. In an embodiment, the lid 128 may include a tab, loop, or opening 129 to allow a user to easily grasp and manipulate the strainer 100 relative to the pitcher container 32. In addition, the lid 128 may include a tab or other feature 135 to provide a user with an access point to easily grasp and manipulate the lid 128 relative to the accessory body 102.

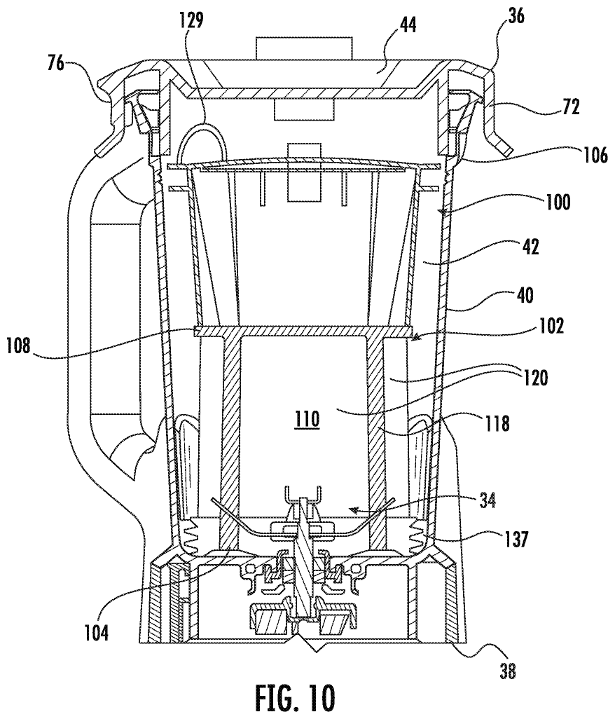

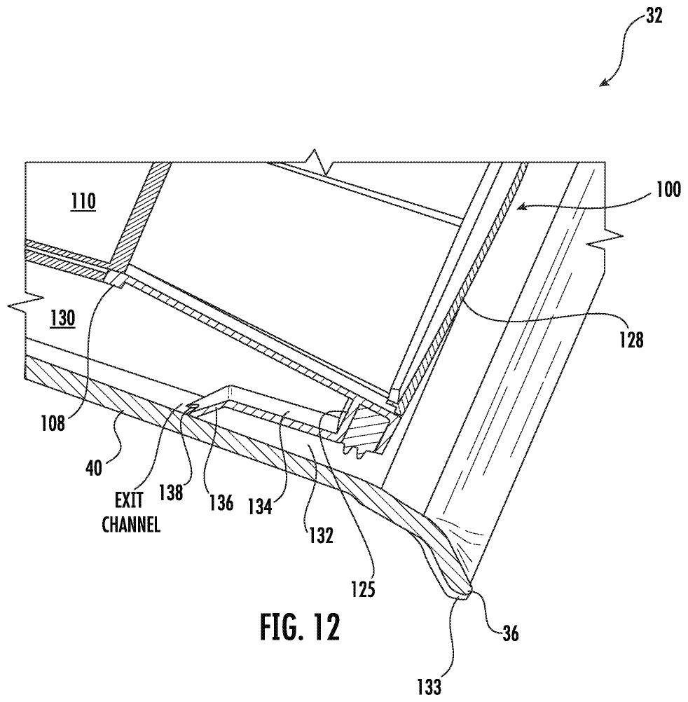

In an embodiment, best shown in FIGS. 10 and 12, a pouring chamber 130 is defined between an interior surface of a sidewall 40 of the pitcher container 32 and the exterior surface of the sidewall 108 of the accessory body 102 positioned within the processing chamber 42. The pouring chamber 130 is arranged in fluid communication with the accessory interior 110 of the accessory body 102 via the at least partially permeable material 120 of the sidewalls 108. A sealing element 137, may extend from or be located adjacent the annular base 116 of the strainer 100 (see FIG. 10). The sealing element assists in positioning the strainer 100 within the processing chamber 42 and prevents the contents of the interior of the strainer 100 from leaking through the lower end 104 of the strainer and into the pouring chamber 130. In an embodiment, the upper end 106 of the body 102 includes a spout region 131 defined by one or more sides 126 of the flange 125 that are shorter in length than a corresponding sidewall 40 of the container 32. When the accessory 100 is installed within the processing chamber 42, the spout region 131, in an embodiment, the spout region is defined adjacent a corner of the pitcher container 32, in alignment with a spout 133 of the container 32. Further, a pouring opening 132 is defined between the spout region 131 and the interior surface of the pitcher container 32 and is arranged in fluid communication with the pouring chamber 130.

Further, in an embodiment, the strainer 100 includes a filtering body 134 operable to restrict the flow from the pouring chamber 130. The filtering body 134 may include a flange, tab, or other protrusion that extends generally downwardly and outwardly from either the lid 128 or from the second end 106 of the accessory body 102, within the pouring chamber 130. As shown, the filtering body 134 extends from an outer periphery of the flange 125 such that the filtering body 134 is offset from an exterior surface of the sidewall 108. In an embodiment, the filtering body 134 extends downwardly from the spout region 131 of the flange 125.

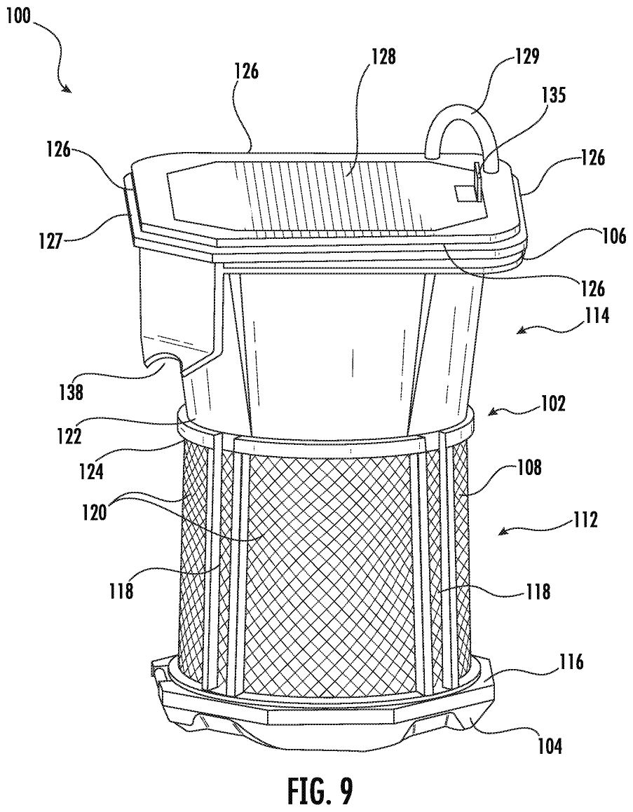

A distal abutting end 136 of the filtering body 134 is configured to abut the interior surface of the pitcher container 32 when the accessory 100 is installed within the processing chamber 42. As shown, the abutting end 136 of the filtering body 134 is arranged at an angle to the rotational axis of the blade assembly 34 toward the interior surface of sidewall 40. The abutting end 136 of the filtering body 134 additionally includes a small cutout or notch 138. Although the cutout 138, best illustrated in FIGS. 8 and 9. has a generally arcuate contour, it should be understood that the contour of the cutout 138 may vary based on the size and/or types of particles that the filtering body 134 is intended to block. Together the notch 138 and the sidewall 40 of the pitcher container 32 define an exit channel operable to generally filter the contents of the pouring chamber 130 as they pass there through. For example, a portion of the portion of flow passing through the exit channel is blocked by the portion of the flange 125 connecting the accessory body 102 and the filtering body 134.

To use the strainer 100, the strainer 100 is installed within the processing chamber 42 of either a container 32 or a vacuum container 32, such that the rotatable blades 35 of the blade assembly 34 are located within the accessory interior 110 of the strainer 100. One or more food items to be processed are installed into the accessory interior 110 through the open second upper end 106 of the accessory body 102. Once the desired contents are installed therein, the lid 128 may be used to seal the upper end 106 of the accessory body 102 and the lid 44 may be positioned to seal the container 32. It should be understood that adding ingredients to be processed as described herein may include adding one or more ingredients to the processing chamber 42, at a position separate from and external to the accessory interior 110.

Once all of the desired ingredients have been added, a food processing operation may be performed to process or mix the food located within the accessory interior 110. As the food is processed, a portion of the processed food will migrate through the permeable portion of the sidewalls 108 of the accessory body 102; however, larger particles will remain trapped within the accessory interior 110, separate from the pouring chamber 130. Further, if a liquid was added to the processing chamber 42, the liquid is circulated through and mixed with the contents of the processing chamber 42, such as to infuse the liquid with the contents of the accessory interior 110. In embodiments where the container 32 is a vacuum container, a vacuum operation (i.e. reducing the pressure within the processing chamber 42 and therefore the accessory interior 110) may be performed prior to initiating the food processing operation. However, it should be understood that a vacuum operation may be performed at any time during such a food processing/infusion operation.

Once a desired level of fusion, mixing, and/or blending has been achieved, a user removes the lid 44 from the first end of the container 36 to pour the contents of the processing chamber 42, and more specifically, the contents of the pouring chamber 130 into a separate vessel. As best shown in FIG. 12, when the container 32 including the strainer 100 is in a tilted configured, the pulp and other non-desirable or waste ingredients remain trapped within the accessory interior 110 of the strainer 100. The fluid and the finely processed food particular within the pouring chamber 130 is directed towards the filtering body 134. As a result of the configuration of the filtering body 134, and more specifically of the exit channel defined between the filtering body 134 and the sidewall 40 of the container 32, only liquid, and in some embodiments finely processed food particulate are able to pass through the exit channel. Other byproducts of the processing operation, such as foam for example, are skimmed from the fluid and directed toward the portion of the flange 125 extending between the filtering body 134 and the accessory body 102, while the remaining fluid passes through the exit channel. Accordingly, only the most desirable contents are output from the spout region at the second upper end of the accessory body 102.

A strainer accessory 100 as illustrated and described herein when used in conjunction with a vacuum mechanism 52 prior to a food processing operation may provide a food product having increased vitamin retention, specifically vitamin C Exposure to oxygen during the blending process may cause the ingredients within the container 32 to degrade. By removing the oxygen from the container 32, the overall degradation of the nutritional properties of the ingredients being processes is reduced. Further, the infusion of the ingredients into a fluid may be additionally enhanced. In addition, use of the strainer in conjunction with a vacuum mechanism 52 may reduce the amount of undesirable foam produced during the food processing operation.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An accessory for use in a food processing system having a processing chamber in a container with an interior surface and a rotatable blade assembly, the accessory comprising:
an accessory body receivable within the processing chamber of the attachment, said accessory body having an upper end, a lower end, and at least one sidewall extending between said first end and said second end to define an accessory interior;
an opening to said accessory interior at said upper end; and
a filtering body extending from said accessory body, said filtering body being associable with the interior surface of the container to create an exit channel from the processing chamber.

2. The accessory of claim 1, wherein a filtering flange connects said filtering body to said accessory body, said filtering flange being positioned to block a portion of a flow from said processing chamber in an area adjacent said exit channel.

3. The accessory of claim 1, wherein at least a portion of said sidewall is permeable to a fluid flow.

4. The accessory of claim 1, wherein said filtering body is positionable within the processing chamber such that said exit channel is aligned with a spout of the container.

5. The accessory of claim 1, wherein said upper end includes a spout region disposed a greater distance from the interior surface of the container than a remainder of said upper end.

6. The accessory of claim 5, wherein said filtering body extends downwardly from said spout region of said accessory body.

7. The accessory of claim 1, wherein said filtering body includes an abutting end for contacting the interior surface of the container, said abutting end having a notch formed therein.

8. The accessory of claim 7, wherein said notch and the interior surface of the container cooperate to define an exit channel.

9. The accessory of claim 1, wherein said accessory body further comprises a lid configurable to selectively seal said opening at said upper end.

10. The accessory of claim 9, wherein said lid is removably associated with said upper end.

11. The accessory of claim 9, wherein said lid is rotatably coupled to said upper end.

12. The accessory of claim 1, wherein said lower end of said accessory body is positionable in contact with a bottom surface of the processing chamber.

13. The accessory of claim 1, wherein said accessory body includes a first portion adjacent said lower end and a second portion adjacent said upper end, said first portion and said second portion having different configurations.

14. The accessory of claim 13, wherein at least one of said first portion and said second portion is generally cylindrical in shape and the other of said first portion and said second portion is generally frustoconical in shape.

15. The accessory of claim 1, further comprising an opening to said accessory interior at said lower end, wherein a diameter of said opening at said lower end is greater than a diameter of the rotatable blade assembly.

16. A container assembly for a food processing system, the container assembly comprising:
a sealable container body including a processing chamber having an interior surface and an open end;
a rotatable blade assembly including at least one blade positioned within said chamber of said sealable body; and
an accessory positionable within said chamber, said accessory including:
an accessory body having an accessory interior;
an upper end in communication with said accessory interior, and
a filtering body extending from said accessory body and arranged in contact with said, said filtering body being associable with said interior surface of said container body to create an exit channel from the processing chamber.

17. The container assembly of claim 16, wherein a filtering flange connects said filtering body to said accessory body, said filtering flange being positioned to block a portion of a flow from said processing chamber in an area adjacent said exit channel.

18. The container assembly of claim 16, wherein said accessory body includes a sidewall and at least a portion of said sidewall is permeable to a fluid flow.

19. The container assembly of claim 16, wherein said container body includes a spout and said exit channel is aligned with said spout.

20. The container assembly of claim 16, wherein said upper end includes a spout region disposed a greater distance from an interior surface of said container body than a remainder of said upper end.

21. The container assembly of claim 20, wherein said filtering body extends downwardly from said spout region of said accessory body.

22. The container assembly of claim 16, wherein said filtering body includes an abutting end for contacting an interior surface of the container, said abutting end having a notch formed therein.

23. The container assembly of claim 22, wherein said notch and the interior surface of the container cooperate to define an exit channel.

24. The container assembly of claim 12, wherein said accessory further comprises a lid connectable to said accessory body to seal said accessory interior.

25. The container assembly of claim 16, wherein said sealable container body includes a vacuum channel selectively arranged in fluid communication with said processing chamber.
